(19) United States
(12) Patent Application Publication
(10) Pub. No.: US 2017/0213492 A1
(43) Pub. Date: Jul. 27, 2017

(54) COLOR UNEVENNESS CORRECTION DEVICE AND COLOR UNEVENNESS CORRECTION METHOD

(71) Applicant: MegaChips Corporation, Osaka (JP)

(72) Inventor: Kazunori Ochiai, Chiba (JP)

(73) Assignee: MegaChips Corporation, Osaka (JP)

(21) Appl. No.: 15/408,729

(22) Filed: Jan. 18, 2017

(30) Foreign Application Priority Data
Jan. 21, 2016 (JP) 2016-009887

(51) Int. Cl. G09G 3/20; G09G 3/36

(52) U.S. Cl. CPC G09G 3/2003; G09G 3/3607; G09G 2320/0242; G09G 2310/08

(57) ABSTRACT

A color unevenness correction device is adapted to the display device that operates in accordance with the write signals supplied to a plurality of color picture elements composing one pixel in a time-division manner through a common signal line. The color unevenness correction device specifies a correction amount based on a first write signal for a first color picture element composing the one pixel and a second write signal for a second color picture element other than the first color picture element composing the pixel and corrects the second write signal in accordance with the correction amount.

### BACKGROUND OF THE INVENTION

Field of the Invention

The present invention relates to color unevenness correction devices and methods, and particularly, to a color unevenness correction device and method for a display device (liquid crystal panel) of a time-sharing signal supply system.

Description of the Related Art

Conventionally, a display device (hereinafter, “time-division display device”), in which a single source driver supplies write signals in a time-division manner to, for example, a red picture element R, a green picture element G, and a blue picture element B composing one pixel, is known. In such time-division devices, the number of source drivers can be reduced to ⅓, compared to a display device that supplies write signals by providing an individual source driver for each color picture element. Advantageously, the time-division device allows the number of connection terminals to be reduced and thus achieves low production costs.

In such time-division display devices generally, wires for supplying signals to both end portions of a screen or panel from the source drivers (hereinafter, “source lines”) are longer than those at the center portion of the screen. Therefore, impedances of the source lines for the both end parts of the screen cannot be ignored. Furthermore, in the time-division display devices, the supply time for the write signals supplied to the color picture elements is ⅓ of the supply time in the display device provided with a separate source driver for each color picture element. Therefore, a phenomenon that the write signal supplied to one color picture element does not have a desirable potential occurs due to influence of the write signals supplied to other color picture elements. As a result, in the time-division display devices, a phenomenon that colors are deviated, among others, between the center part and the both end portions of the screen, although the colors are to be the same.

Japanese Patent Publication No. 2005-234057 discloses a display device that prevents a write signal supplied to a color picture element from being influenced by supply of write signals supplied to other color picture elements.

WO 2012/157093 discloses a display device including a three-dimensional LUT (lookup table) of pixel positions on a screen and write signals. A correction value is extracted from the three-dimensional LUT to correct a write signal, thereby eliminating color unevenness and luminance unevenness.

Japanese Patent Publication No. 2013-232882 discloses a display device including a three-dimensional LUT of color picture elements RGB. A correction value optimal for an area of a screen is extracted to correct a write signal, thereby correcting color unevenness.

In the display device disclosed in Japanese Patent Publication No. 2005-234057, the fact that a length of the source line varies depending on the pixel position on the screen, i.e., the fact that an impedance of the source line varies depending on the pixel position, is not taken into account. Therefore, the display device cannot solve the problem that correct colors cannot be displayed depending on the screen position.

In the display device disclosed in WO 2012/157093, the influence of the write signals supplied to other color picture elements is not taken into account, and thus the color unevenness caused in the time-division display device cannot be solved.

In the display device disclosed in Japanese Patent Publication No. 2013-232882, the three-dimensional LUT for each specific area of the screen is required. Therefore, the display device needs to have a large memory for holding the three-dimensional LUTs.

An object of the present invention is to provide a color unevenness correction device and method that can correct color unevenness caused depending on a screen position in a time-division display device.

### SUMMARY OF THE INVENTION

The present invention for solving the problems may include the following matters specifying the invention and technical features.

An invention according to an aspect provides a color unevenness correction device adapted to a display device that supplies write signals to a plurality of color picture elements composing one pixel through a common signal line in a time-division manner. The color unevenness correction device may specify a correction amount based on a first write signal for a first color picture element composing the one pixel and a second write signal supplied just after the first write signal through the common signal line to a second color picture element other than the first color picture element composing the pixel, and corrects the second write signal in accordance with the correction amount.

An invention according to an aspect provides a color unevenness correction device adapted to a display device that supplies write signals to a plurality of color picture elements composing one pixel through a common signal line in a time-division manner. The color unevenness correction device may include a correction amount determination unit that may determine and output a correction amount based on a write signal to be corrected (i.e., target signal) supplied to one color picture element composing a pixel to be corrected and a latest or immediately preceding write signal supplied to another color picture element immediately before the write signal to be corrected. Further, the color unevenness correction device may include a correction unit that may superimpose the determined correction amount on the write signal to be corrected to correct the write signal to be corrected and output the corrected write signal.

The correction amount determination unit may include an LUT storage unit that may store an LUT defining the correction amount depending on a relationship between a signal level of the write signal to be corrected and a signal level of the latest write signal.

The LUT may include LUT blocks provided in association with a plurality of areas in a screen of the display device.

The color unevenness correction device may further include a position information generation unit that may generate position information indicating a position of the pixel based on the write signal for the pixel to be corrected. If the correction amount determination unit determines that the pixel belongs to one area based on the position information, the correction amount determination unit may select one of LUT blocks corresponding to the one area and specify the correction amount in accordance with the selected LUT block.

If the correction amount determination unit determines that the pixel does not belong to any of the areas based on the position information, the correction amount determination unit may select one of LUT blocks corresponding to at least one area adjacent to the pixel, specify at least one pseudo correction amount according to the selected LUT block. The correction amount determination unit may then apply a predetermined interpolation process to the specified pseudo correction amount to determine the correction amount, and output the correction amount.

The color unevenness correction device may further include a line butler for storing, as the latest write signal, a write signal for one color picture element composing a pixel of a scan line immediately preceding the pixel to be corrected.

The present invention according to an aspect provides a color unevenness correction device adapted to a display device that supplies write signals to a plurality of color picture elements composing one pixel through a common signal line in a time-division manner. The color unevenness correction device may include a correction amount determination unit that may determine and output a correction amount based on a first write signal to be corrected supplied to one color picture element composing a pixel to be corrected and a second write signal supplied after the first write signal through the common signal line to another color picture element composing the pixel different from the write signal to be corrected. Further, the color unevenness correction device may include a correction unit that may superimpose the determined correction amount on the first write signal to be corrected to correct the write signal to be corrected and that output the corrected write signal.

The present invention according to an aspect provides a color unevenness correction method adapted to a display device that supplies write signals to a plurality of color picture elements composing one pixel through a common signal line in a time-division manner. The method may include fetching a first write signal for a first color picture element composing the one pixel and a second write signal for a second color picture element other than the first color picture element composing the pixel, and specifying a correction amount based on the imported first write signal and second write signal. Further, the method may include correcting the second write signal according to the specified correction amount.

The present invention according to an aspect provides a control circuit configured to supply write signals, in a time-division manner, through a common signal line to a display device in which a plurality of color picture elements composing one pixel are connected to the common signal line. The control circuit may include a color unevenness correction device that may specify a correction amount based on a first write signal for a first color picture element composing the one pixel and a second write signal for a second color picture element other than the first color picture element composing the pixel. The control circuit may correct the second write signal in accordance with the correction amount.

According to the present invention, the color unevenness correction device and method in a time-division display device can correct color unevenness caused due to a screen position.

Other technical features, objects, effects, and advantages of the present invention will become apparatus from the following embodiments described with reference to the attached drawings.

### BRIEF DESCRIPTION OF THE DRAWINGS

FIG. 1A is a block diagram illustrating a display device to which a color unevenness correction device according to an embodiment of the present invention is applied;

FIG. 1B is a block diagram illustrating the display device in which a color unevenness correction device according to an embodiment of the present invention is applied;

FIG. 2 is a block diagram illustrating a color unevenness correction device according to an embodiment of the present invention;

FIG. 3A is a diagram illustrating an example of areas in a display unit according to an embodiment of the present invention:

FIG. 3B is a diagram illustrating an example of areas of a screen of a display device according to an embodiment of the present invention;

FIG. 4 is a diagram showing an example of an LUT in a display device according to an embodiment of the present invention;

FIG. 5 is a conceptual diagram illustrating a color unevenness correction process in a color unevenness correction device according to an embodiment of the present invention;

FIG. 6 is a flow chart showing a color unevenness correction method according to an embodiment of the present invention;

FIG. 7A is a diagram showing a result of simulation of color unevenness on the screen in a case that a color unevenness correction method according to an embodiment of the present invention is used;

FIG. 7B is a diagram showing a result of a simulation of a color unevenness on the screen in a case that a color unevenness correction method according to the present invention is not used; and

FIG. 8 is a block diagram for describing a color unevenness correction device according to an embodiment of the present invention.

### DETAILED DESCRIPTION OF THE PREFERRED EMBODIMENTS

Embodiments of the present invention will now be described with reference to the drawings. However, the embodiments described below are illustrative only, and the embodiments are not intended to exclude application of various modifications and techniques not illustrated below. Various modifications (e.g. combinations of embodiments) may be made and carried out without departing from the scope of the present invention. In the following description of the drawings, the same or similar references are provided to indicate the same or similar parts. The drawings are schematic, and the drawings may not illustrate the actual dimensions, ratios, etc. The drawings may include parts where dimensional relationships or ratios are different from each other.

The present embodiments disclose a technique in a color unevenness correction device that corrects color unevenness in a time-division display device for supplying, in a time-division manner, write signals to a plurality of color picture elements composing each pixel, wherein a write signal for a first color picture element may be corrected by referring to a write signal for a second color picture element different from the first color picture element.

### First Embodiment

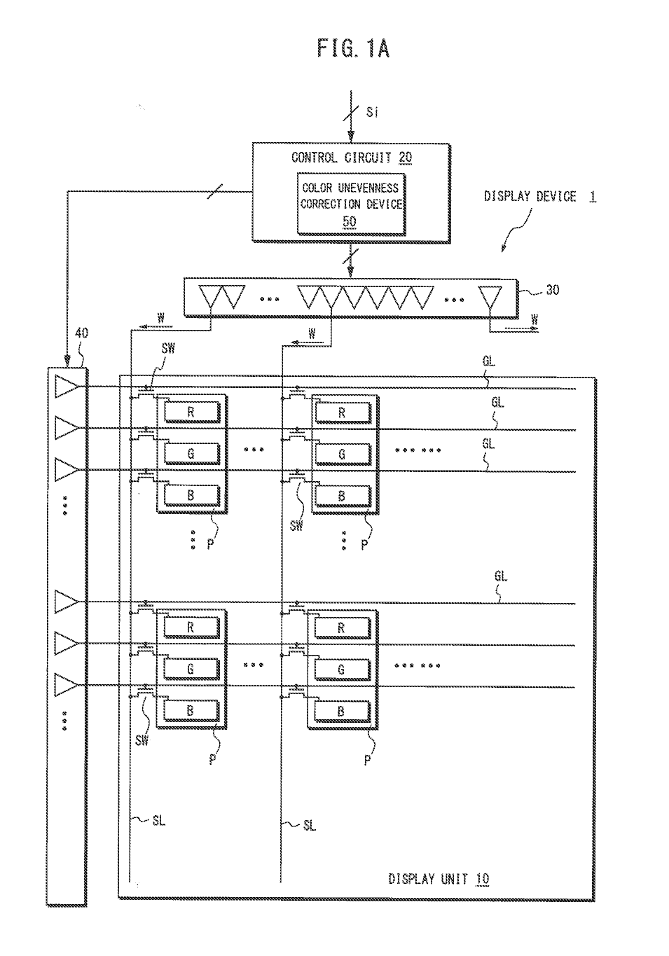

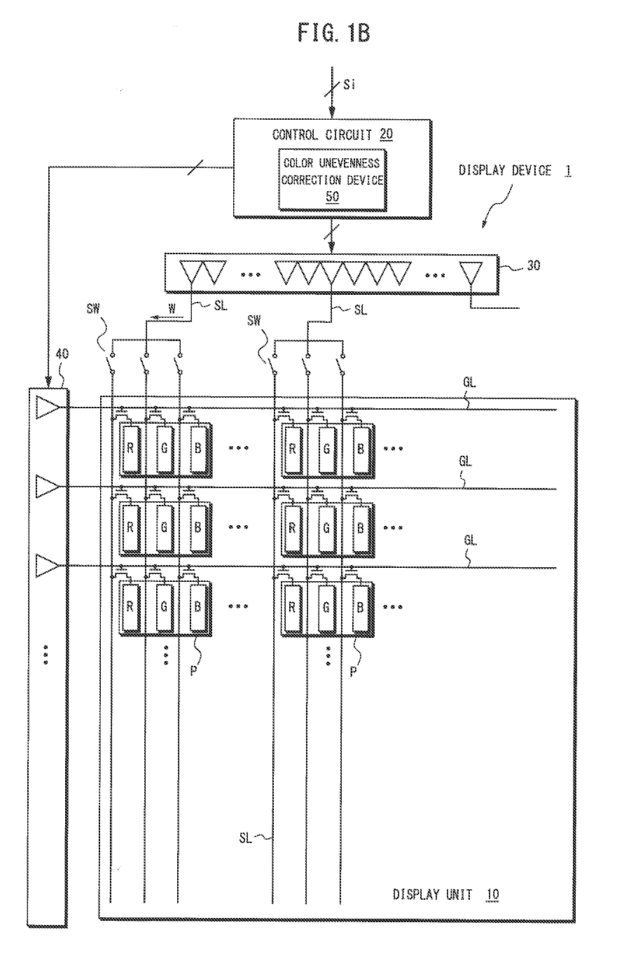

FIGS. 1A and 1B are block diagrams illustrating a display device in which a color unevenness correction device according to an embodiment of the present invention may be applied. As shown in FIGS. 1A and 1B, a display device 1 may include a display unit 10, a control circuit 20, and a plurality of source drivers 30 and a plurality of gate drivers 40 for driving the display unit 10 under the control by the control circuit 20.

As shown in FIG. 1A, the display unit 10 may include a screen (panel) including a plurality of pixels P arranged in a matrix in X-Y directions (i.e., horizontal and vertical directions). Each of the plurality of pixels P may include, for example, three types of color picture elements (sub-pixels), i.e., a red picture element R, a green picture element G, and a blue picture element B. In the present example, the display unit 10 may be configured such that one source driver 30 may drive the color picture elements composing the pixels P arranged in the vertical direction through a common signal line (source line SL). Therefore, the number of source drivers 30 may correspond to the number of pixels P in the horizontal direction, and the number of source drivers 30 is ⅓, compared to a case in which the source driver 30 drives each color picture element. On the other hand, the number of gate drivers 40 for the pixels P arranged in the Y direction may be three times. The display unit 10 configured this way may be called a tri-gate panel. It is noted that a pixel P positioned in an x-th line in the X direction and a y-th line in the Y direction on the basis of the upper left pixel P of the display unit 10 may be expressed as a pixel P(x, y) for the convenience.

The control circuit 20 may be a circuit that may control driving of the plurality of source drivers 30 and the plurality of gate drivers 40 based on an image signal Si supplied from the outside. More specifically, the control circuit 20 may receive, for example, the image signal Si compliant to an LVDS standard and generate RGB signals and control signals (e.g., position signals of a horizontal synchronizing signal and a vertical synchronizing signal) from the received image signal Si. The control circuit 20 may selectively drive specific source drivers 30 and specific gate drivers 40 at a predetermined timing based on the generated control signal. The control circuit 20 may include a color unevenness correction device 50 described later that corrects write signals W.

The plurality of source drivers 30 may supply the write signals W to the pixels P through the source lines SL under the control of the control circuit 20. As described above, the source drivers 30 may be provided in accordance with the number of pixels P in the horizontal direction. Therefore, each of the plurality of source drivers 30 may selectively be driven for one hold period by the vertical synchronization signal from the control circuit 20 based on the image signal Si, and the source driver 30 may supply the write signals W to the corresponding pixels P through the source line SL. In this example, the write signals W for each pixel P may include write signals W(R), W(G), and W(B) continuously supplied to the color picture elements RGB, respectively, in a time-division manner.

The plurality of gate drivers 40 may control on/off of the pixels P arranged in the X direction through gate lines GL under the control of the control circuit 20. As described above, the gate drivers 40 may be provided in accordance with the number of entire color picture elements composing the pixels P in the vertical direction. More specifically, each of the plurality of gate drivers 40 may selectively be driven by the horizontal synchronizing signal from the control circuit 20 based on the image signal Si, and as a result, the gate driver 40 may turn on a drive transistor operably connected to the gate line GL. The drive transistor may be a transistor such as a TFT.

According to the configuration, the source drivers 30 for specific pixels P may selectively be driven under the control of the control circuit 20 based on the image signal Si, and the write signals W(R), MG), and W(B) may sequentially be supplied to the corresponding source lines in a time-division manner. Meanwhile, the gate drivers 40 for the color picture elements in the specific pixel P may selectively be driven in accordance with the time-division-based supply. As a result, the write signals W(R), W(G), and W(B) may sequentially be drawn in from the source lines SL through switches SW, and the write signals W(R), W(G), and W(B) may be written in the color picture elements RGB composing the specific pixels P, respectively. In this way, the entire screen of the display unit 10 may be scanned, and a desirable image may be displayed.

It is noted that as shown for example in FIG. 1B, the display unit 10 may be configured such that color picture element groups of the same colors in the pixel groups P arranged in the Y direction may be operably connected to the source drivers 30 through the common source lines SL, through the switches SW. In this case, the gate drivers, 40 may be provided in accordance with the number of pixels P in the Y direction. The control circuit 20 may control on/off of the switches SW provided on the source lines SL for the pixels P arranged in the X direction to selectively supply the write signals W(R), W(G), and W(B) to the color picture elements RGB composing the specific pixels P. In this case, although the number of gate drivers 40 is ⅓ compared to the configuration shown in FIG. 1A, switches for switching the source lines and control thereof may be necessary.

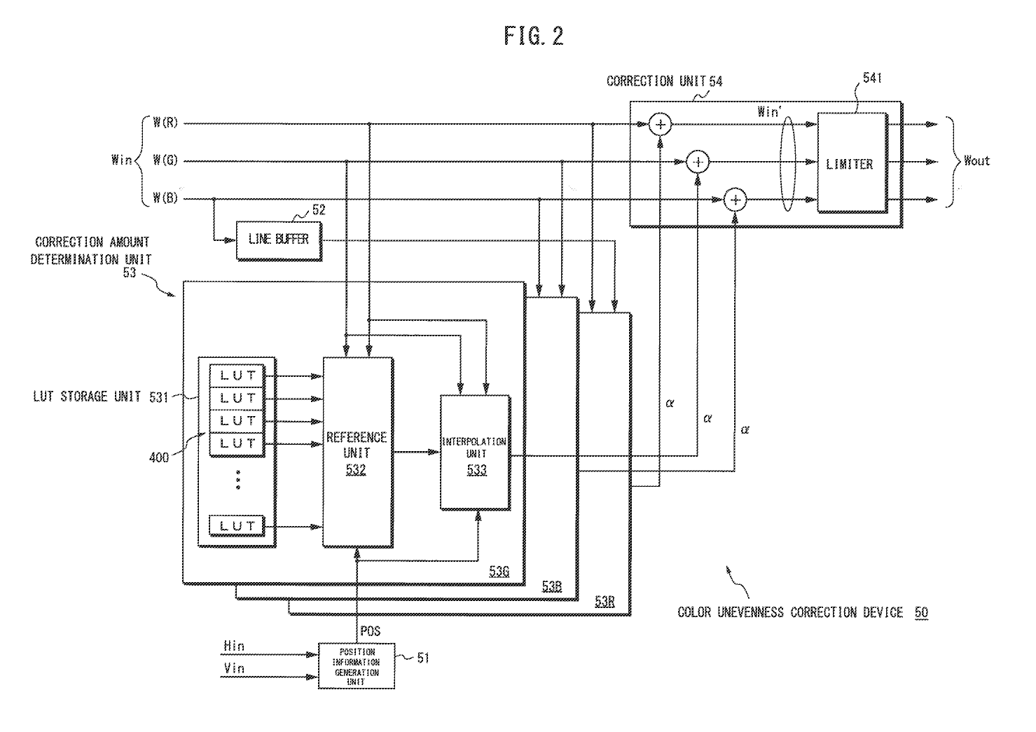

FIG. 2 is a block diagram illustrating the color unevenness correction device according to an embodiment of the present invention. The color unevenness correction device 50 may correct input write signals Win to eliminate unintended color unevenness in the image and then outputs the corrected write signals Wout.

As shown in FIG. 2, the color unevenness correction device 50 may include a position information generation unit 51, a line buffer 52, a correction amount determination unit 53, a correction unit 54, and a limiter 541.

The position information generation unit 51 may generate position information POS of the pixels P in the panel in accordance with a horizontal synchronizing signal Hin and a vertical synchronizing signal Vin based on the image signal Si.

The line buffer 52 may be a buffer for holding the write signals W supplied to the pixel groups P specific color picture elements) of the latest scan line. More specifically, in this example, the line buffer 52 may hold the write signals Win supplied to the last color picture elements (write signals W(B) supplied to blue picture elements B in this example) composing the pixel groups P of the latest scan line in a time-division manner, so that levels of signal strengths (signal levels) of the write signals W relative to adjacent color picture elements (e.g., red picture elements R and blue picture elements B) of the pixels P adjacent to each other in the vertical direction can be referenced.

The correction amount determination unit 53 may determine correction amounts a for the write signals Win supplied to the pixels P indicated by the generated position information POS. Specifically, the correction amount determination unit 53 may determine the correction amounts α for the write signals W(R), W(G), and W(B) supplied to the color picture elements composing the pixels P indicated by the generated position information POS. Therefore, in this example, the correction amount determination unit 53 may be configured to include a correction amount determination unit 53R for red picture element that may determine the correction amount for the write signal W(R), a correction amount determination unit 53G for green picture element that may determine the correction amount for the write signal W(G), and a correction amount determination unit 53B for blue picture element that may determine the correction amount for the write signal W(B).

The correction amount determination units 53R, 53G, and 53B for color picture elements may have the same internal basic configuration, and for example, each of the correction amount determination units 53R, 53G, and 53B for color picture elements may include an LUT storage unit 531, a reference unit 532, and an interpolation unit 533.

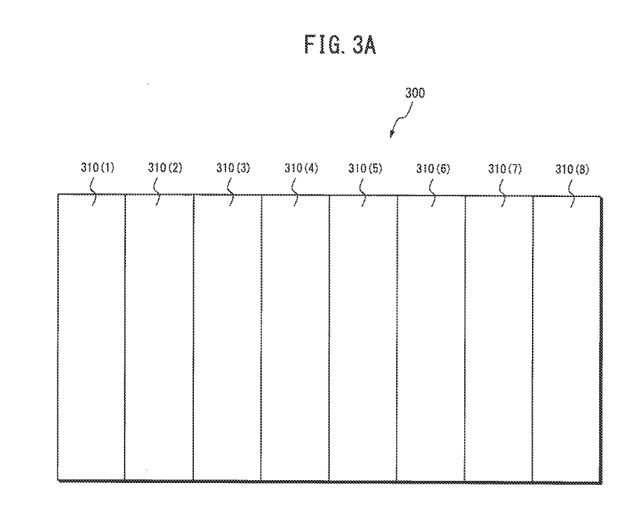

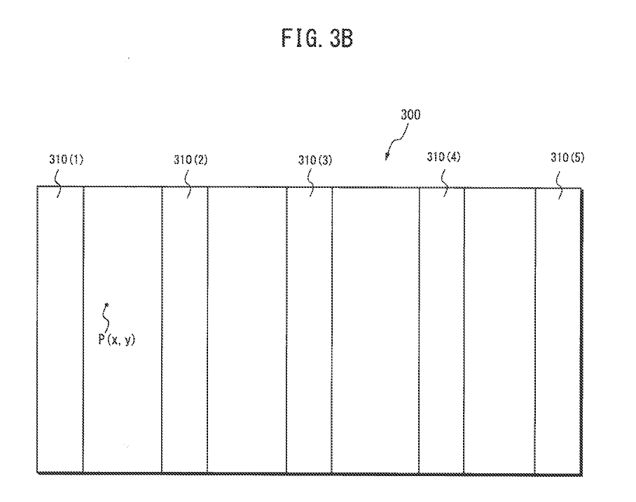

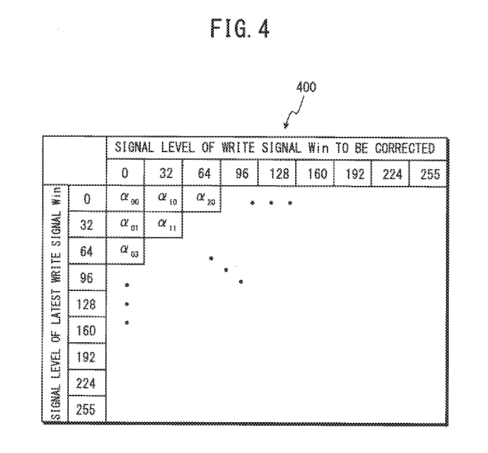

The LUT storage unit 531 may store a lookup table (LUT) 400 which may defines the correction amounts a in association with the signal levels of the write signals W supplied to the color picture elements adjacent to each other (see FIG. 4). Although the LUT may be configured to define the correction amounts α for the color picture elements in all pixels P of the display unit 10, the LUT of the present example may include a plurality of LUT blocks, each defining the correction amounts α of each of a plurality of areas in the panel of the display unit 10, in order to reduce the memory size. For example, the panel characteristics of the display unit 10 may be the same in the vertical direction for manufacturing reasons. Therefore, common LUT blocks may be used in the vertical direction in consideration of the fact that the color unevenness caused by the wire length of the source lines SL is the same in the vertical direction of the display unit 10. More specifically, as shown for example in FIG. 3A, the entire screen of the display unit 10 may be divided into eight band-like areas 310(1) to 310(8) in the X direction, and the LUT block may be associated with each of the areas 310. As another example, areas 310(1) to 310(5) may be defined for discrete sections of the screen as shown in FIG. 3B, and the LUT block may be associated with each of the areas 310. In this case, the LUT block for the area at a center part of the screen may be omitted. Alternatively, although not shown, the screen of the display unit 10 may be divided in a grid, and the LUT blocks may be allocated to the divided areas (or discrete areas). The areas 310 may or may not have the same shape and the same size. Different LUTs may be used for the correction amount determination units 53R, 53G, and 53B for color picture elements, or common LUTs may be used for all or part of the correction amount determination units 53R, 53G, and 53B for color picture elements (e.g., correction amount determination units 53G and 53B for color picture elements). Further, the screen of the display unit 10 may be divided into bilaterally symmetrical areas, and common LUTs may be used on the left and right. For example, the LUT blocks of the areas 310(1) and 310(5) may be common, and the LUT blocks of the areas 310(2) and 310(4) may be common in the example shown in FIG. 3B.

FIG. 4 is a diagram showing an example of the LUT (LUT block) in the display unit 10 according to an embodiment of the present invention. As shown in FIG. 4, the LUT 400 may define the correction amounts a specified by a relationship between the signal level of the latest write signal Win and the signal level of the write signal Win to be corrected. The signal level may be, for example, defined in nine levels obtained by dividing the values 0 to 255 of the signal potential by 32. For example, in the LUT 400 of the correction amount determination unit 53G for green picture element, the write signal Win to be corrected may be the write signal Win supplied to the green picture element G, and the latest write signal Win is the write signal Win supplied to the red picture element R. In the LUT 400 of the correction amount determination unit 53B for blue picture element, the write signal Win to be corrected may be the write signal Win supplied to the blue picture element B, and the latest write signal Win may be the write signal Win supplied to the green picture element G. In the LUT 400 of the correction amount determination unit 53R for red picture element in the present embodiment, the write signal Win to be corrected may be the write signal Win supplied to the red picture element R, and the latest write signal Win may be the write signal Win supplied to the given picture element G of the latest scan line.

Returning to FIG. 2, the reference unit 532 may select one or two corresponding LUT blocks in accordance with the position information POS output from the position information generation unit 51 and refer to the selected LUT blocks to specify the correction amount a corresponding to the signal levels of two write signals W supplied temporally in succession to color picture elements adjacent to each other. The reference unit 532 may then output the specified correction amount α to the interpolation unit 533.

Specifically, the reference unit 532 first may specifys the position of the pixel P where the write signal Win to be corrected is supplied, based on the position information POS output from the position information generation unit 51. The reference unit 532 may then determine whether the position of the pixel P belongs to one of the areas. If the reference unit 532 determines that the position belongs to one of the areas, the reference unit 532 may select one LUT block allocated to the area from the plurality of LUT blocks stored in the LUT storage unit 531. On the other hand, if the reference unit 532 determines that the position does not belong to one of the areas, the reference unit 532 may select one or two LUT blocks of areas adjacent to the pixel P. For example, the reference unit 532 may select the area 310(1) and the area 310(2) in a case of a pixel (x, y) in the screen as shown in FIG. 3B.

The reference unit 532 may further determine the signal levels of the write signal Win to be corrected and the latest write signal Win and specifies the correction amount a from the LUT 400 of the LUT storage unit 531. For example, in the correction amount determination unit 530 for green picture element, the reference unit 532 may determine the signal level of the write signal W(R) supplied to the red picture element R and then determine the signal level of the write signal W(G) supplied to the green picture element G to thereby specify the correction amount α. In the correction amount determination unit 53B for blue picture element, the reference unit 532 may determine the signal level of the write signal W(G) supplied to the green picture element G and then determine the signal level of the write signal W(B) supplied to the blue picture element B to thereby specify the correction amount α. In the correction amount determination unit 53R for red picture element, the reference unit 532 may determine the signal level of the write signal W(B) supplied to the blue picture element B of the latest scan line read from the line buffer 52 and the signal level of the write signal W(R) supplied to the red picture element R to thereby specify the correction amount α.

If the pixel P to be corrected does not belong to any of the defined areas, the interpolation unit 533 may execute a predetermined interpolation process based on two or more correction amounts α output from the reference unit 532 to calculate the correction amount α. More specifically, if the position information POS output from the position information generation unit 51 does not belong to the defined areas, the interpolation unit 533 may use, for example, a linear interpolation method to calculate the correction amount α based on two correction amounts α (hereinafter, “pseudo correction amounts α′”) specified from two LUT blocks corresponding to two adjacent areas. Alternatively, the interpolation unit 533 may set a relationship between the two pseudo correction amounts α′ specified from the two LUT blocks as a function in accordance with the wire length of the source lines SL, and calculate the correction amount α by multiplying one of the pseudo correction amounts α′ by a gain of the function.

On the other hand, if the position of the pixel P where the write signal Win to be corrected is supplied belongs to one of the areas, the interpolation unit 533 may output the correction amount α output from the reference unit 532. It is noted that the interpolation unit 533 can be omitted in a case where the LUT blocks corresponding to the areas defined for the entire screen of the display unit 10 are provided.

The correction unit 54 may superimpose the correction amount α output from the interpolation unit 533 on the input write signal Win to correct the write signal Win and outputs a corrected write signal Win′. Therefore, the correction unit 54 may superimpose the correction amounts α output from the interpolation units 533 of the correction amount determination units 53R, 53G, and 53B for color picture elements on the input write signals Win for the color picture elements to thereby correct the write signals Win and outputs the corrected write signals Win′. The correction unit 54 may include, for example, the limiter 541.

The limiter 541 may limit the signal so that the write signal Wout to be output falls within a predetermined dynamic range. More specifically, the limiter 541 may process the signal so that the signal potential of the corrected write signal Win′ may fall within the predetermined dynamic range and output the processed write signal Win′ as a final write signal Wout.

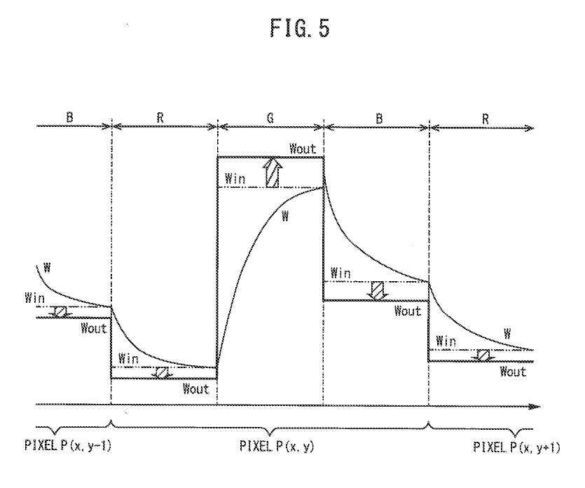

FIG. 5 is a conceptual diagram illustrating the color unevenness correction process in the color unevenness correction device according to an embodiment of the present invention. FIG. 5 shows an example of the write signals W supplied to a pixel P(x, y). The horizontal axis denotes time, and the vertical axis denotes signal potential of the write signals W. In this example, the write signals W for the pixel P(x, y) is continuously supplied in order of the write signals W(R), W(G), and W(B).

With reference to FIG. 5, for example, the write signals W may sequentially be supplied in a time-division manner to the color picture elements RGB composing the pixel P(x, y), and the signal potential may be determined at a fall of a timing clock not shown. In this case, the signal waveform may become dull, and a write signal W(x) with unintended signal potential as indicated by a thin solid line emerges, due to the influence of the remaining capacity or the like on the source line SL caused by the write signal W(x) for another color picture element supplied immediately before. Therefore, the color unevenness correction device 50 corrects the current write signal W(x) to be corrected based on the relationship with the signal potential of a write signal W(x-1) supplied immediately before, in order to obtain intended signal potential. In FIG. 5, the write signals Win input to the color unevenness correction device 50 are indicated by alternate long and two short dashes line, and the write signals Wout to be output are indicated by thick solid lines. More specifically, as shown for example in FIG. 5, the write signal W(R) may be corrected to reduce the signal potential, and the write signal W(G) may be corrected to increase the signal potential in the pixel P(x, y). The write signal W(B) may be corrected to decrease the signal potential. As described above, the correction amount α may be determined by a relationship between the current write signal W(x) to be corrected and the write signal W(x-1) supplied immediately before. As a result, the write signal W(x) may be corrected to the intended signal potential, and an image with intended coloring may be displayed on the panel of the display unit 10.

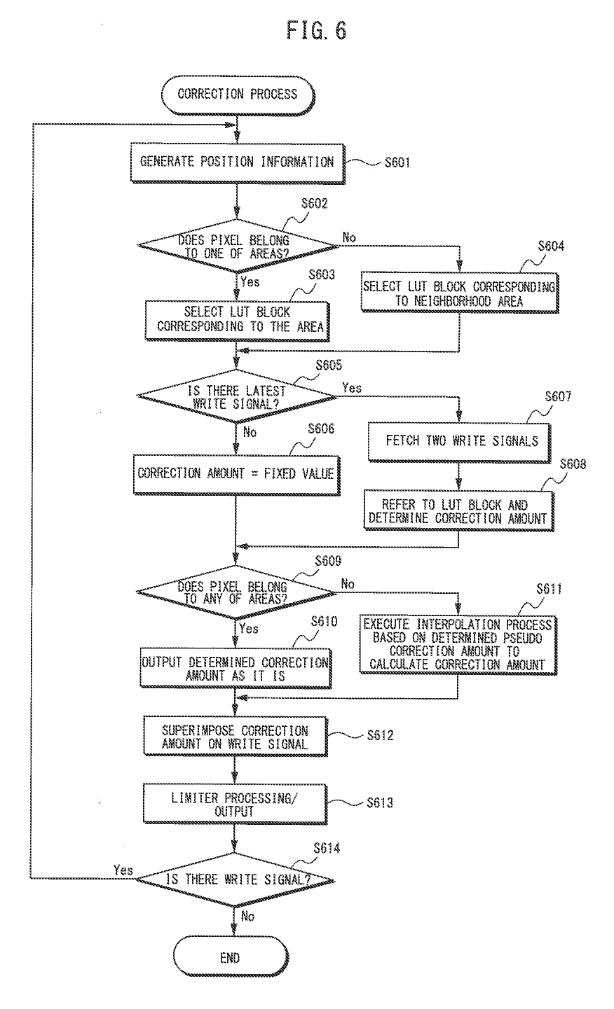

FIG. 6 is a flow chart showing a color unevenness correction method according to an embodiment of the present invention. The color unevenness correction method may be one or more processes executed by the color unevenness correction device 50.

As shown in FIG. 6, the position information generation unit 51 may generate the position information POS indicating the position of the pixel P based on the horizontal synchronizing signal Hin and the vertical synchronizing signal Vin on the basis of the image signal Si (S601). The reference unit 532 may then determine whether the pixel P indicated by the position information POS output from the position information generation unit 51 belongs to one of the areas 310 (S602).

If the reference unit 532 determines that the pixel P belongs to one of the areas 310 (Yes in S602), the reference unit 532 may select the LUT block associated with the area 310 from the plurality of LUT blocks stored in the LUT storage unit 531 (S603). On the other hand, if the reference unit 532 determines that the pixel P does not belong to any of the areas 310 (No in S602), the reference unit 532 may select one or two LUT blocks associated with the areas 310 near the pixel P from the plurality of LUT blocks stored in the LUT storage unit 531 (S604). For example, the pixel P(x, y) shown in FIG. 3B does not belong to any of the areas 310, and the reference unit 532 may select the LUT blocks associated with the areas 310(1) and 310(2) near pixel P(x, y).

The reference unit 532 may then determine whether a write signal Win immediately preceding the write signal Win for the color picture element to be corrected (S605) exists. Here, a case where it is determined that no latest write signal Win (No in S605) exists means a case where the first red picture element R of the first line of the panel of the display unit 10, i.e., the first red picture element R composing the pixel group P(x, 1) in the first line in the Y direction, is to be corrected. In this case, the reference unit 532 may set the correction amount α to a predetermined fixed value and output the correction amount α to the interpolation unit 533 (S606).

On the other hand, if the reference unit 532 determines that a latest write signal Win exists (Yes in S605), the reference unit 532 may fetch two write signals Win (S607). The two write signals Win may be the write signal Win for the color picture element to be corrected and the latest write signal Win. For example, the write signal Win for the red picture element R of the same pixel P may be the latest write signal Win of the green picture element G to be corrected. The reference unit 532 may refer to the selected LUT block to specify the corresponding correction amount α according to the two imported write signals Win and outputs the correction amount α to the interpolation unit (S608). It is noted that for the second and subsequent lines in the Y direction, the write signal Win for the blue picture element B of the latest line may be fetched for the red picture element R from the line buffer 52.

The interpolation unit 533 may also determine whether the pixel P indicated by the position information POS output from the position information generation unit 51 belongs to one of the areas 310 (S609). The interpolation unit 533 may be configured to receive the information related to whether the pixel P belongs to one of the areas 310 from the reference unit 532. If the interpolation unit 533 determines that the pixel P belongs to one of the areas 310 (Yes in S609), the interpolation unit 533 may output the correction amount α as it is (S610). On the other hand, if the interpolation unit 533 determines that the pixel P does not belong to any of the areas 310 (No in S609), the interpolation unit 533 may apply a predetermined interpolation process to the pseudo correction amount α′ output from the reference unit 532 to obtain the correction amount α and outputs the correction amount α (S611).

The correction unit 54 may superimpose the correction amount α on the write signal Win for the color picture element to be corrected (S612). The limiter 541 may then limit the corrected write signal Win′ so that the corrected write signal Win′ falls within a predetermined range and outputs the signal as a write signal Wout (S613). The color unevenness correction device 50 may determine whether there is a write signal Win for the color picture element to be corrected next (S614). If the color unevenness correction device 50 determines that a write signal Win exists (Yes in S614), the color unevenness correction device 50 may return to the process of S601 to continue the correction process.

As described above, the color unevenness correction device 50 may utilize the write signal Win for the color picture element to be corrected and the latest write signal Win to obtain the correction amount a and superimposes the correction amount a on the write signal Win to be corrected to output the write signal Wout. By way of this, when the write signals W are supplied to the color picture elements in a time-division manner, the influence of the write signal W supplied immediately before is taken into account to correct the current write signal W, and the display device 1 can display a desirable image without color unevenness. Among others, as differences between impedances caused by differences between the lengths of the source lines SL are taken into account to correct the write signals W, the color unevenness generated between the center portion and the end portion s of the panel can be eliminated.

Furthermore, the color unevenness correction device 50 may specify the correction amount a according to two write signals W, i.e., the write signal Win for the color picture element to be corrected and the latest write signal Win. Therefore, the structure of the LUT can be simplified, and the size of the LUT storage unit 531 can be reduced, and thus the reduction in the cost of the display device 1 can be realized.

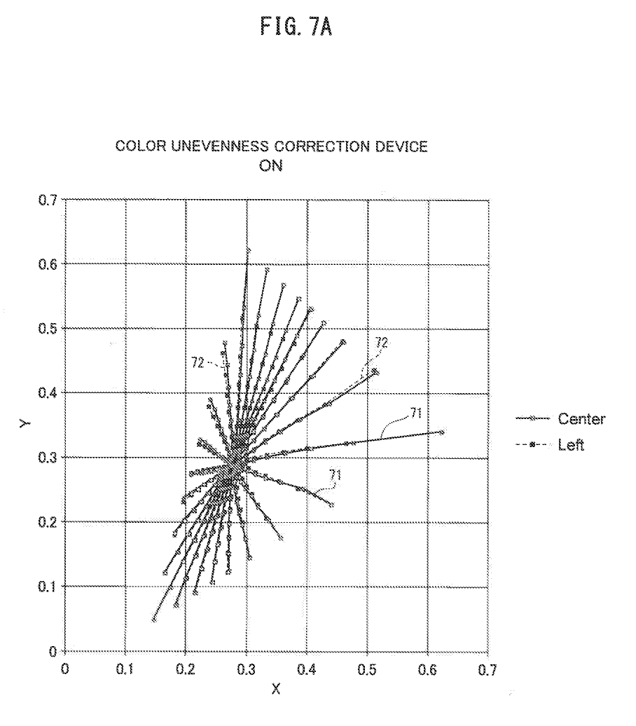

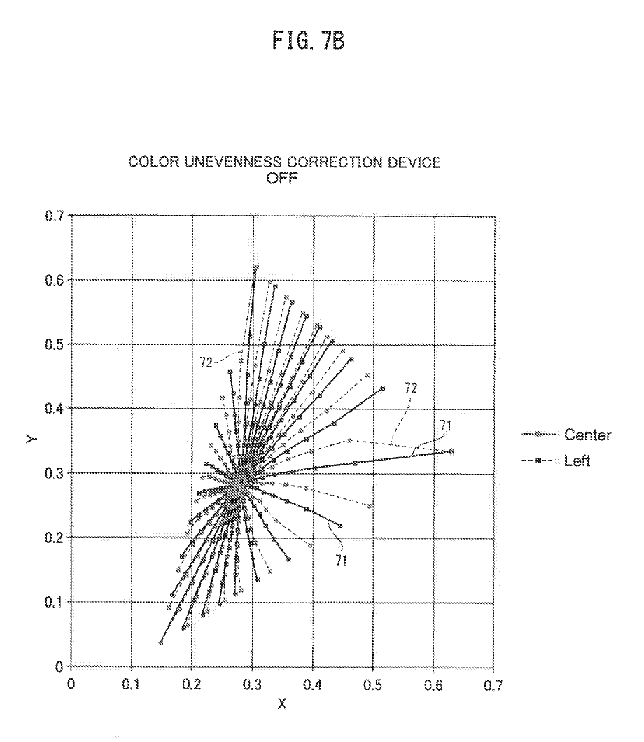

FIG. 7A is a diagram showing a result of measurement of the color unevenness on the screen of the display unit 10 in a case where the color unevenness correction method according to an embodiment of the present invention is used. FIG. 7B is a diagram of a comparative example, showing a result of measurement of the color unevenness on the screen of the display unit 10 in a case where the color unevenness correction method is not used. FIGS. 7A and 7B are xy chromatid diagrams. Solid lines 71 indicate chromaticity values of pixels P at the center of the panel of the display unit 10 based on predetermined write signals W, and broken lines 72 indicate chromaticity values of pixels P′ on the left side of the panel based on the same write signals W. Therefore, there is no color unevenness between the center and the left side of the panel if the solid lines 71 and the broken lines 72 overlap in the drawing.

With reference to FIG. 7B, in a case where the color unevenness correction method of the present embodiment is not used, the chromaticity values of the pixels P at the center of the screen and the chromaticity values of the pixels P on the left side of the panel are partially deviated, and it can be recognized that there is inherent color unevenness in the panel. On the other hand, in a case where the color unevenness correction method of the present embodiment is used, the chromaticity values of the pixels P at the center of the screen and the chromaticity values of the pixels P on the left side of the panel substantially coincide throughout each color space as shown in FIG. 7A. It can be recognized that the color unevenness specific to the panel is effectively eliminated.

### Second Embodiment

The present embodiment discloses a color unevenness correction device configured to use the write signals W for the color picture elements composing the pixels P of the same scan line to specify the correction amount α. In other words, for the color picture elements composing a pixel P(x, y) to be corrected adjacent to a pixel P(x, y-1) of the latest scan line, the color unevenness correction device of the present embodiment may be configured to use the write signals for the color picture elements composing the same pixel P(x, y) to specify the correction amount α, instead of using the write signals W for the adjacent color picture elements composing the pixel P(x, y-1) of the latest scan line.

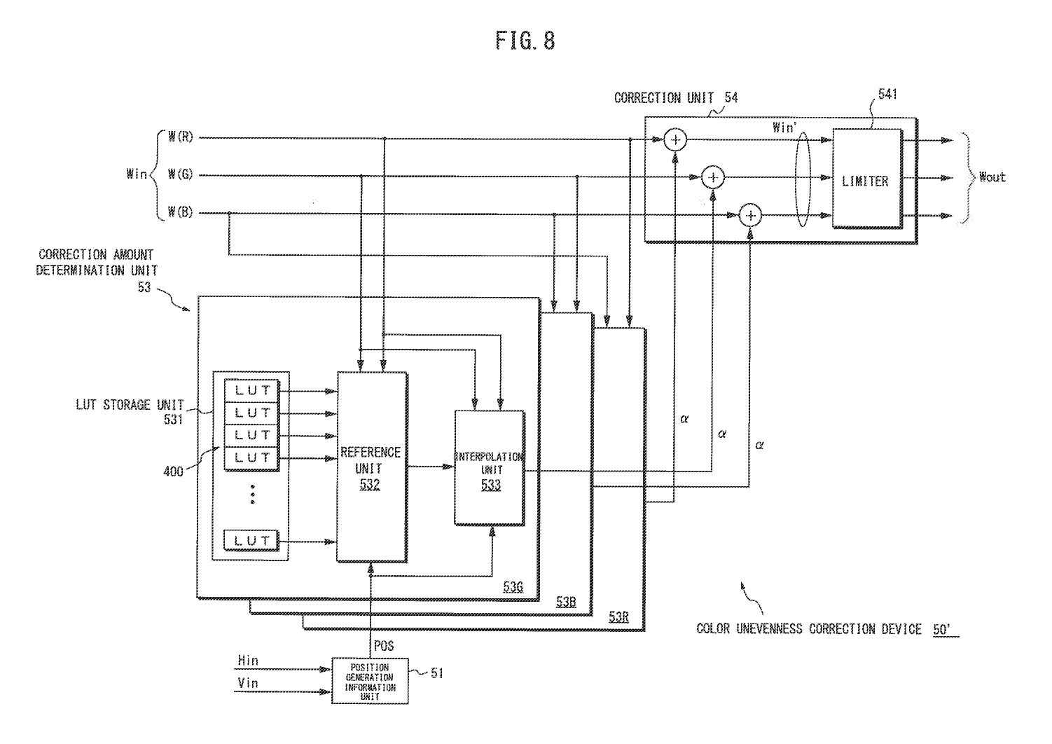

FIG. 8 is a block diagram illustrating the color unevenness correction device according to an embodiment of the present invention.

As shown in FIG. 8, a color unevenness correction device 50′ of the present embodiment does not include the line buffer 52 for holding the write signals W for the color picture elements of the immediately preceding scan line.

Therefore, in a case where, for example, the write signals Win are supplied to the color unevenness correction device 50′ in a time-division manner in order of the write signals W(R), W(G), and W(B) for the color picture elements composing the pixel P to be corrected, the correction amount determination unit 53G for green picture element may refer to the LUT 400 based on the write signal W(G) supplied to the green picture element G and the write signal W(R) supplied to the red picture element R to specify the correction amount α. The correction amount determination unit 53B for blue picture element may refer to the LUT 400 based on the write signal W(B) supplied to the blue picture element B and the write signal W(G) supplied to the green picture element G to specify the correction amount α. The correction amount determination unit 53R for red picture element may refer to the LUT 400 based on the write signal W(R) supplied to the red picture element R and the write signal W(B) supplied to the blue picture element B to specify the correction amount α.

As described above, the color unevenness correction device 50′ may use the write signals Win for the color picture elements in the same pixel P to obtain the correction amount α and superimpose the correction amount α on the write signal Win to be corrected to output the write signal Wout. By way of this, in a case where the write signals W are supplied to the color picture elements in a time-division manner, the influence of the write signals W supplied immediately before may be taken into account to correct the current write signal W. Therefore, the display device 1 can display a desirable image without color unevenness. Among others, the color unevenness correction device 50′ does not use the write signals Win for the color picture elements composing the pixels P of the latest scan line. Therefore, the line buffer may not be provided, and the cost can be reduced. The color correction apparatus 50′ of the present embodiment can also attain the advantageous effects of the color unevenness correction as described above based on the fact that the color unevenness of a color with a rather large area on the screen is conspicuous.

The embodiments are examples for describing the present invention, and the embodiments are not intended to limit the present invention only to the embodiments. The present invention can be carried out in various modes without departing from the scope of the present invention.

For example, the steps, the operations, or the functions may be carried out in parallel or in different order in the method disclosed in the present specification as long as the results are not contradictory. The described steps, operations, and functions are just provided as examples. Some of the steps, the operations, and the functions may be eliminated without departing from the scope of the invention or may be combined to form one step, operation, or function. Other steps, operations, or functions may also be added.

Although various embodiments are disclosed in the present specification, a specific feature (technical matter) in one embodiment may be added to another embodiment while appropriately improving the feature, or the feature may be replaced by a specific feature in the other embodiment. Such a mode is also included in the scope of the present invention.

For example, although the write signals W for the color picture elements composing the pixel P are supplied in a time-sharing manner in order of the write signals W(R), W(G), and W(B) in the embodiments, the order is not limited to this. The color picture elements are not limited to the three types, and other color picture elements may be added.

### INDUSTRIAL APPLICABILITY

The present invention can be widely used in a field of a display device of a time-sharing system.

What is claimed is:

1. A color unevenness correction device adapted to a display device that operates in accordance with write signals supplied in a time-division manner to a plurality of color picture elements composing one pixel through a common signal line, comprising a circuit,
wherein the circuit specifies a correction amount based on a first write signal for a first color picture element composing the one pixel and a second write signal supplied just after the first write signal through the common signal line to a second color picture element other than the first color picture element composing the pixel and corrects the second write signal according to the correction amount.

2. A color unevenness correction device adapted to a display device that operates according to write signals supplied in a time-division manner to a plurality of color picture elements composing one pixel through a common signal line, the color unevenness correction device comprising:
a correction amount determination unit that determines a correction amount based on a write signal to be corrected supplied to one color picture element composing a pixel to be corrected and a latest write signal supplied to another color picture element immediately before the write signal to be corrected and outputs the correction amount; and
a correction unit that superimposes the determined correction amount on the write signal to be corrected to correct the write signal to be corrected and outputs the corrected write signal.

3. The color unevenness correction device according to claim 2, wherein the correction amount determination unit comprises an LUT storage unit that stores an LUT defining the correction amount in accordance with a relationship between a signal level of the write signal to be corrected and a signal level of the latest write signal.

4. The color unevenness correction device according to claim 3, wherein the LUT includes LUT blocks provided according to a plurality of areas in a screen of the display device.

5. The color unevenness correction device according to claim 4, further comprising a position information generation unit that generates position information indicating a position of the pixel based on the write signal for the pixel to be corrected,
wherein if the correction amount determination unit determines that the pixel belongs to one area based on the position information, the correction amount determination unit selects an LUT block corresponding to the one area and specifies the correction amount according to the selected LUT block.

6. The color unevenness correction device according to claim 5, wherein if the correction amount determination unit determines that the pixel does not belong to any of the areas based on the position information, the correction amount determination unit selects an LUT block corresponding to at least one area adjacent to the pixel, specifies at least one pseudo correction amount according to the selected LUT block, applies a predetermined interpolation process to the specified pseudo correction amount to determine the correction amount, and outputs the correction amount.

7. The color unevenness correction device according to claim 2, further comprising a line buffer for storing, as the latest write signal, a write signal for one color picture element composing a pixel of a scan line immediately preceding the pixel to be corrected.

8. A color unevenness correction device adapted to a display device that operates according to write signals supplied in a time-division manner to a plurality of color picture elements composing one pixel through a common signal line, the color unevenness correction device comprising:
a correction amount determination unit that determines a correction amount based on a first write signal to be corrected supplied to one color picture element composing a pixel to be corrected and a second write signal supplied after the first write signal through the common signal line to another color picture element composing the pixel different from the write signal to be corrected and that outputs the correction amount; and
a correction unit that superimposes the determined correction amount on the first write signal to be corrected to correct the write signal to be corrected, and outputs the corrected write signal.

9. A color unevenness correction method adapted to a display device that operates in accordance with write signals supplied in a time-division manner to a plurality of color picture elements composing one pixel through a common signal line, the method comprising:
fetching a first write signal for a first color picture element composing the one pixel and a second write signal for a second color picture element other than the first color picture element composing the pixel;
specifying a correction amount based on the imported first write signal and second write signal; and
correcting the second write signal in accordance with the specified correction amount.

10. A control circuit configured to supply write signals in a time-division manner through a common signal line to a display device in which a plurality of color picture elements composing one pixel are connected to the common signal line, the control circuit comprising a color unevenness correction device,
wherein color unevenness correction device specifies a correction amount based on a first write signal for a first color picture element composing the one pixel and a second write signal for a second color picture element other than the first color picture element composing the pixel, and corrects the second write signal in accordance with the correction amount.
